(19) United States
(12) Patent Application Publication
(10) Pub. No.: US 2026/0089482 A1
(43) Pub. Date: Mar. 26, 2026

(54) UE ROUTE SELECTION POLICY RULE PROTECTION WHILE ROAMING

(71) Applicant: Lenovo (Singapore) Pte. Ltd., Singapore (SG)

(72) Inventors: Andreas KUNZ, Ladenburg (DE); Dimitrios KARAMPATSIS, Ruislip (GB); Sheeba Backia Mary BASKARAN, Friedrichsdorf (DE)

(21) Appl. No.: 19/112,924

(22) PCT Filed: Nov. 30, 2022
(86) PCT No.: PCT/EP2022/083825

§ 371 Date: Mar. 18, 2025

(30) Foreign Application Priority Data
Oct. 10, 2022 (GR) 20220100828

(51) Int. Cl. H04W 8/12; H04W 12/102; H04W 40/20

(52) U.S. Cl. CPC H04W 8/12; H04W 12/102; H04W 40/20

(57) ABSTRACT

There is provided a first network function in a home network, wherein the home network is arranged to communicate with a visited network, the first network function comprising: a transceiver; and a processor coupled to the transceiver. The processor and the transceiver are configured to cause the first network function to: send a request message to a second network function in the home network, the request message comprising user equipment routing selection policy, ‘URSP’, data; receive from the second network function, and in response to the request message, a message comprising protected URSP data; and send a user equipment policy update request comprising the protected URSP data to the third network function for delivery to the user equipment.

### FIELD

The subject matter disclosed herein relates generally to the field of implementing UE route selection policy rule protection while roaming. This document defines a first network function in a home network, a method in a first network function in a home network, a user equipment in a visited network, and a method in a user equipment in a visited network.

### BACKGROUND

In 3GPP networks a Policy Control Function (PCF) has the following responsibilities:
Policy rules for application and service data flow detection, gating, QoS, and flow based charging to the Session Management Function (“SMF”);
Access and Mobility Management related policies to the Access and Mobility Management Function (“AMF”); and
Provisioning of UE policies (i.e. UE Route Selection Policy (URSP) rules) to the UE via the AMF.

Since Release 15 onwards of the 3GPP specifications URSP rules have been defined to allow a UE to determine how to route application traffic through a mobile communication network either via 3GPP access or via non-3GPP access with the options of an untrusted or trusted WLAN access or to route the traffic non-seamlessly bypassing the mobile communication network via a WLAN connection. The URSP rules and the procedures for the UE to apply URSP rules are described in 3GPP TS 23.502 v17.4.0 and 3GPP TS 23.503 v17.4.0 (URSP rules definitions and procedures are included from version 15.0.0 onwards of 23.502 and 23.503).

A UE with a valid International Mobile Subscriber Identifier may roam from its home public land mobile network (H-PLMN) and access service in the roamed to area by using a visited PLMN (V-PLMN). If a communication has been established, the UE will in principle not suffer an interruption within the PLMN area.

### SUMMARY

A problem with existing implementations of URSP rules is that a Visited-PLMN may benefit if the data in URSP messages from the Home-PLMN is tampered with. In the case of provisioning an unprotected URSP rule, the Visited-PLMN could rewrite the URSP rule to save resources locally or downgrade the QoS for specific services, which then may lead to a bad user experience or service disruptions for the user equipment.

Disclosed herein are procedures for UE route selection policy rule protection while roaming. Said procedures may be implemented by a first network function in a home network, a method in a first network function in a home network, a user equipment in a visited network, and a method in a user equipment in a visited network.

There is provided a first network function in a home network, wherein the home network is arranged to communicate with a visited network, the first network function comprising: a transceiver; and a processor coupled to the transceiver. The processor and the transceiver are configured to cause the first network function to: send a request message to a second network function in the home network, the request message comprising user equipment routing selection policy, ‘URSP’, data; receive from the second network function, and in response to the request message, a message comprising protected URSP data; and send a user equipment policy update request comprising the protected URSP data to the third network function for delivery to the user equipment.

By delivering protected URSP data to the UE, the first network function in a home network facilitates the UE being able to verify whether the protected URSP data sent by the first network function matches a URSP rule received from the visited network. The UE is thus able to determine if a URSP rule received from the visited network is authentic.

There is further provided a method in a first network function in a home network, wherein the home network is arranged to communicate with a visited network. The method comprises: sending a request message to a second network function in the home network, the request message comprising user equipment routing selection policy, ‘URSP’, data; receiving from the second network function, and in response to the request message, a message comprising protected URSP data; and sending a user equipment policy update request comprising the protected URSP data to the third network function for delivery to the user equipment.

There is further provided a user equipment comprising: a transceiver; and a processor coupled to the transceiver. The processor and the transceiver configured to cause the user equipment to: receive a user equipment policy update request comprising a protected user equipment routing selection policy, ‘URSP’, data while roaming in a visited network; and verify the integrity of the received URSP data.

There is further provided a method in a user equipment, the method comprising: receiving a user equipment policy update request comprising a protected user equipment routing selection policy, ‘URSP’, data while roaming in a visited network; and verifying the integrity of the received URSP data.

### BRIEF DESCRIPTION OF THE DRAWINGS

In order to describe the manner in which advantages and features of the disclosure can be obtained, a description of the disclosure is rendered by reference to certain apparatus and methods which are illustrated in the appended drawings. Each of these drawings depict only certain aspects of the disclosure and are not therefore to be considered to be limiting of its scope. The drawings may have been simplified for clarity and are not necessarily drawn to scale.

Methods and apparatus for UE route selection policy rule protection while roaming will now be described, by way of example only, with reference to the accompanying drawings, in which:

FIG. 1 depicts a wireless communication system that may employ UE route selection policy rule protection while roaming;

FIG. 2 depicts a user equipment apparatus that may be used for implementing the methods described herein;

FIG. 3 depicts further details of a network node that may be used for implementing the methods described herein;

FIG. 4 illustrates a Visited-PLMN tampering with a URSP rule being sent to a roaming UE;

FIG. 5 illustrates a method for URSP rule protection when a UE is roaming in a Visited-PLMN;

FIG. 6 illustrates a method in a first network function in a home network, wherein the home network is arranged to communicate with a visited network; and

FIG. 7 illustrates a method in a user equipment.

### DETAILED DESCRIPTION

As will be appreciated by one skilled in the art, aspects of this disclosure may be embodied as a system, apparatus, method, or program product. Accordingly, arrangements described herein may be implemented in an entirely hardware form, an entirely software form (including firmware, resident software, micro-code, etc.) or a form combining software and hardware aspects.

For example, the disclosed methods and apparatus may be implemented as a hardware circuit comprising custom very-large-scale integration (“VLSI”) circuits or gate arrays, off-the-shelf semiconductors such as logic chips, transistors, or other discrete components. The disclosed methods and apparatus may also be implemented in programmable hardware devices such as field programmable gate arrays, programmable array logic, programmable logic devices, or the like. As another example, the disclosed methods and apparatus may include one or more physical or logical blocks of executable code which may, for instance, be organized as an object, procedure, or function.

Furthermore, the methods and apparatus may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In certain arrangements, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

Reference throughout this specification to an example of a particular method or apparatus, or similar language, means that a particular feature, structure, or characteristic described in connection with that example is included in at least one implementation of the method and apparatus described herein. Thus, reference to features of an example of a particular method or apparatus, or similar language, may, but do not necessarily, all refer to the same example, but mean “one or more but not all examples” unless expressly specified otherwise. The terms “including”, “comprising”, “having”, and variations thereof, mean “including but not limited to”, unless expressly specified otherwise. An enumerated listing of items does not imply that any or all of the items are mutually exclusive, unless expressly specified otherwise. The terms “a”, “an”, and “the” also refer to “one or more”, unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one, and only one, of any single item in the list. For example, “one of A, B and C” includes only A, only B or only C and excludes combinations of A, B and C. As used herein, “a member selected from the group consisting of A, B, and C” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Furthermore, the described features, structures, or characteristics described herein may be combined in any suitable manner. In the following description, numerous specific details are provided, such as examples of programming, software modules, user selections, network transactions, database queries, database structures, hardware modules, hardware circuits, hardware chips, etc., to provide a thorough understanding of the disclosure. One skilled in the relevant art will recognize, however, that the disclosed methods and apparatus may be practiced without one or more of the specific details, or with other methods, components, materials, and so forth. In other instances, well-known structures, materials, or operations are not shown or described in detail to avoid obscuring aspects of the disclosure.

Aspects of the disclosed method and apparatus are described below with reference to schematic flowchart diagrams and/or schematic block diagrams of methods, apparatuses, systems, and program products. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams.

The code may also be loaded onto a computer, other programmable data processing apparatus, or other devices to cause a series of operational steps to be performed on the computer, other programmable apparatus, or other devices to produce a computer implemented process such that the code which executes on the computer or other programmable apparatus provides processes for implementing the functions/acts specified in the schematic flowchart diagrams and/or schematic block diagram.

The schematic flowchart diagrams and/or schematic block diagrams in the Figures illustrate the architecture, functionality, and operation of possible implementations of apparatuses, systems, methods, and program products. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

The description of elements in each figure may refer to elements of proceeding Figures. Like numbers refer to like elements in all Figures.

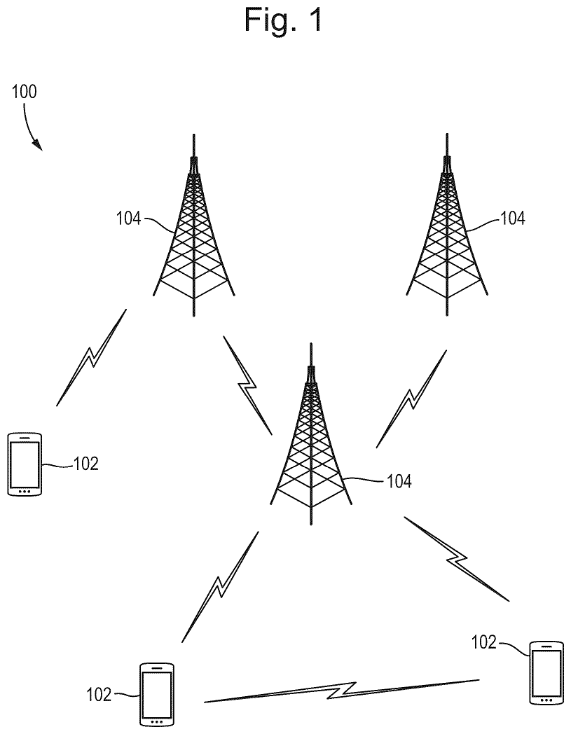

FIG. 1 depicts an embodiment of a wireless communication system 100 for UE route selection policy rule protection while roaming. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to as an access point, an access terminal, a base, a base station, a Node-B, an eNB, a gNB, a Home Node-B, a relay node, a device, a core network, an aerial server, a radio access node, an AP, NR, a network entity, an Access and Mobility Management Function (“AMF”), a Unified Data Management Function (“UDM”), a Unified Data Repository (“UDR”), a UDM/UDR, a Policy Control Function (“PCF”), a Radio Access Network (“RAN”), an Network Slice Selection Function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), an application function, a service enabler architecture layer (“SEAL”) function, a vertical application enabler server, an edge enabler server, an edge configuration server, a mobile edge computing platform function, a mobile edge computing application, an application data analytics enabler server, a SEAL data delivery server, a middleware entity, a network slice capability management server, or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with New Radio (NR) protocols standardized in 3GPP, wherein the network unit 104 transmits using an Orthogonal Frequency Division Multiplexing (“OFDM”) modulation scheme on the downlink (DL) and the remote units 102 transmit on the uplink (UL) using a Single Carrier Frequency Division Multiple Access (“SC-FDMA”) scheme or an OFDM scheme. More generally, however, the wireless communication system 100 may implement some other open or proprietary communication protocol, for example, WiMAX, IEEE 802.11 variants, GSM, GPRS, UMTS, LTE variants, CDMA2000, Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

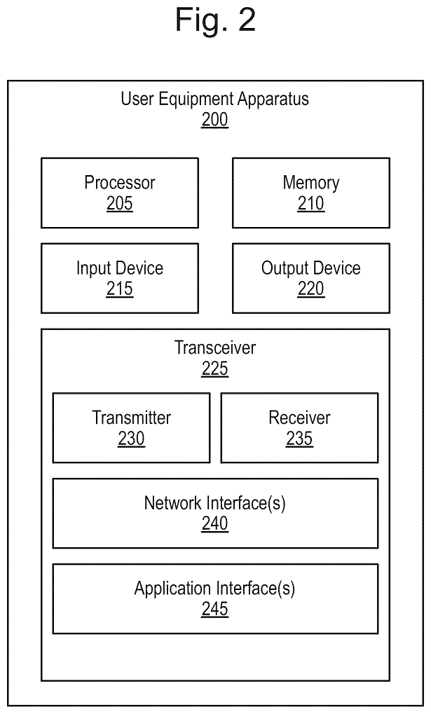

FIG. 2 depicts a user equipment apparatus 200 that may be used for implementing the methods described herein. The user equipment apparatus 200 is used to implement one or more of the solutions described herein. The user equipment apparatus 200 is in accordance with one or more of the user equipment apparatuses described in embodiments herein. In particular, the user equipment apparatus 200 may comprise a remote unit 102, a UE 410 and/or a UE 510 as described herein. The user equipment apparatus 200 includes a processor 205, a memory 210, an input device 215, an output device 220, and a transceiver 225.

The input device 215 and the output device 220 may be combined into a single device, such as a touchscreen. In some implementations, the user equipment apparatus 200 does not include any input device 215 and/or output device 220. The user equipment apparatus 200 may include one or more of: the processor 205, the memory 210, and the transceiver 225, and may not include the input device 215 and/or the output device 220.

As depicted, the transceiver 225 includes at least one transmitter 230 and at least one receiver 235. The transceiver 225 may communicate with one or more cells (or wireless coverage areas) supported by one or more base units. The transceiver 225 may be operable on unlicensed spectrum. Moreover, the transceiver 225 may include multiple UE panels supporting one or more beams. Additionally, the transceiver 225 may support at least one network interface 240 and/or application interface 245. The application interface(s) 245 may support one or more APIs. The network interface(s) 240 may support 3GPP reference points, such as Uu, N1, PC5, etc. Other network interfaces 240 may be supported, as understood by one of ordinary skill in the art.

The processor 205 may include any known controller capable of executing computer-readable instructions and/or capable of performing logical operations. For example, the processor 205 may be a microcontroller, a microprocessor, a central processing unit (“CPU”), a graphics processing unit (“GPU”), an auxiliary processing unit, a field programmable gate array (“FPGA”), or similar programmable controller. The processor 205 may execute instructions stored in the memory 210 to perform the methods and routines described herein. The processor 205 is communicatively coupled to the memory 210, the input device 215, the output device 220, and the transceiver 225.

The processor 205 may control the user equipment apparatus 200 to implement the user equipment apparatus behaviors described herein. The processor 205 may include an application processor (also known as “main processor”) which manages application-domain and operating system (“OS”) functions and a baseband processor (also known as “baseband radio processor”) which manages radio functions.

The memory 210 may be a computer readable storage medium. The memory 210 may include volatile computer storage media. For example, the memory 210 may include a RAM, including dynamic RAM (“DRAM”), synchronous dynamic RAM (“SDRAM”), and/or static RAM (“SRAM”). The memory 210 may include non-volatile computer storage media. For example, the memory 210 may include a hard disk drive, a flash memory, or any other suitable non-volatile computer storage device. The memory 210 may include both volatile and non-volatile computer storage media.

The memory 210 may store data related to implement a traffic category field as described herein. The memory 210 may also store program code and related data, such as an operating system or other controller algorithms operating on the apparatus 200.

The input device 215 may include any known computer input device including a touch panel, a button, a keyboard, a stylus, a microphone, or the like. The input device 215 may be integrated with the output device 220, for example, as a touchscreen or similar touch-sensitive display. The input device 215 may include a touchscreen such that text may be input using a virtual keyboard displayed on the touchscreen and/or by handwriting on the touchscreen. The input device 215 may include two or more different devices, such as a keyboard and a touch panel.

The output device 220 may be designed to output visual, audible, and/or haptic signals. The output device 220 may include an electronically controllable display or display device capable of outputting visual data to a user. For example, the output device 220 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 220 may include a wearable display separate from, but communicatively coupled to, the rest of the user equipment apparatus 200, such as a smart watch, smart glasses, a heads-up display, or the like. Further, the output device 220 may be a component of a smart phone, a personal digital assistant, a television, a table computer, a notebook (laptop) computer, a personal computer, a vehicle dashboard, or the like.

The output device 220 may include one or more speakers for producing sound. For example, the output device 220 may produce an audible alert or notification (e.g., a beep or chime). The output device 220 may include one or more haptic devices for producing vibrations, motion, or other haptic feedback. All, or portions, of the output device 220 may be integrated with the input device 215. For example, the input device 215 and output device 220 may form a touchscreen or similar touch-sensitive display. The output device 220 may be located near the input device 215.

The transceiver 225 communicates with one or more network functions of a mobile communication network via one or more access networks. The transceiver 225 operates under the control of the processor 205 to transmit messages, data, and other signals and also to receive messages, data, and other signals. For example, the processor 205 may selectively activate the transceiver 225 (or portions thereof) at particular times in order to send and receive messages.

The transceiver 225 includes at least one transmitter 230 and at least one receiver 235. The one or more transmitters 230 may be used to provide uplink communication signals to a base unit of a wireless communication network. Similarly, the one or more receivers 235 may be used to receive downlink communication signals from the base unit. Although only one transmitter 230 and one receiver 235 are illustrated, the user equipment apparatus 200 may have any suitable number of transmitters 230 and receivers 235. Further, the transmitter(s) 230 and the receiver(s) 235 may be any suitable type of transmitters and receivers. The transceiver 225 may include a first transmitter/receiver pair used to communicate with a mobile communication network over licensed radio spectrum and a second transmitter/receiver pair used to communicate with a mobile communication network over unlicensed radio spectrum.

The first transmitter/receiver pair may be used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. The first transmitter/receiver pair and the second transmitter/receiver pair may share one or more hardware components. For example, certain transceivers 225, transmitters 230, and receivers 235 may be implemented as physically separate components that access a shared hardware resource and/or software resource, such as for example, the network interface 240.

One or more transmitters 230 and/or one or more receivers 235 may be implemented and/or integrated into a single hardware component, such as a multi-transceiver chip, a system-on-a-chip, an Application-Specific Integrated Circuit (“ASIC”), or other type of hardware component. One or more transmitters 230 and/or one or more receivers 235 may be implemented and/or integrated into a multi-chip module. Other components such as the network interface 240 or other hardware components/circuits may be integrated with any number of transmitters 230 and/or receivers 235 into a single chip. The transmitters 230 and receivers 235 may be logically configured as a transceiver 225 that uses one more common control signals or as modular transmitters 230 and receivers 235 implemented in the same hardware chip or in a multi-chip module.

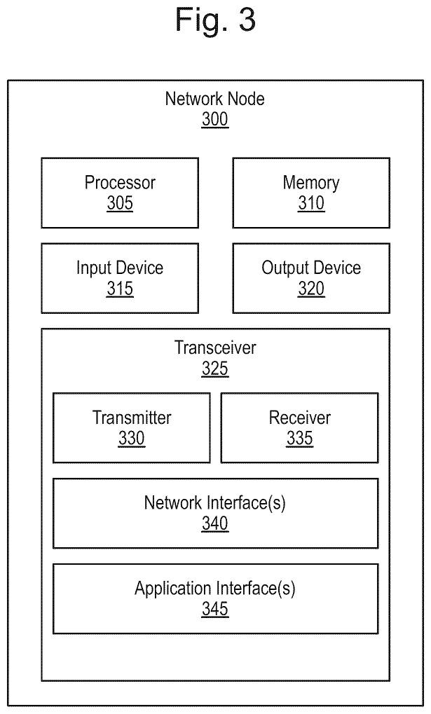

FIG. 3 depicts further details of the network node 300 that may be used for implementing the methods described herein. The network node 300 may be one implementation of an entity in the wireless communication network, e.g. in one or more of the wireless communication networks described herein. The network node 300 may comprise an H-PCF 452, V-PCF 422, SMF 424, AMD 426, V-PCF 522, SMF 524, AMF 526, H-PCF 552, UDM 558 and/or an AUSF 560 as described herein. The network node 300 includes a processor 305, a memory 310, an input device 315, an output device 320, and a transceiver 325.

The input device 315 and the output device 320 may be combined into a single device, such as a touchscreen. In some implementations, the network node 300 does not include any input device 315 and/or output device 320. The network node 300 may include one or more of: the processor 305, the memory 310, and the transceiver 325, and may not include the input device 315 and/or the output device 320.

As depicted, the transceiver 325 includes at least one transmitter 330 and at least one receiver 335. Here, the transceiver 325 communicates with one or more remote units 200. Additionally, the transceiver 325 may support at least one network interface 340 and/or application interface 345. The application interface(s) 345 may support one or more APIs. The network interface(s) 340 may support 3GPP reference points, such as Uu, N1, N2 and N3. Other network interfaces 340 may be supported, as understood by one of ordinary skill in the art.

The processor 305 may include any known controller capable of executing computer-readable instructions and/or capable of performing logical operations. For example, the processor 305 may be a microcontroller, a microprocessor, a CPU, a GPU, an auxiliary processing unit, a FPGA, or similar programmable controller. The processor 305 may execute instructions stored in the memory 310 to perform the methods and routines described herein. The processor 305 is communicatively coupled to the memory 310, the input device 315, the output device 320, and the transceiver 325.

The memory 310 may be a computer readable storage medium. The memory 310 may include volatile computer storage media. For example, the memory 310 may include a RAM, including dynamic RAM (“DRAM”), synchronous dynamic RAM (“SDRAM”), and/or static RAM (“SRAM”). The memory 310 may include non-volatile computer storage media. For example, the memory 310 may include a hard disk drive, a flash memory, or any other suitable non-volatile computer storage device. The memory 310 may include both volatile and non-volatile computer storage media.

The memory 310 may store data related to establishing a multipath unicast link and/or mobile operation. For example, the memory 310 may store parameters, configurations, resource assignments, policies, and the like, as described herein. The memory 310 may also store program code and related data, such as an operating system or other controller algorithms operating on the network node 300.

The input device 315 may include any known computer input device including a touch panel, a button, a keyboard, a stylus, a microphone, or the like. The input device 315 may be integrated with the output device 320, for example, as a touchscreen or similar touch-sensitive display. The input device 315 may include a touchscreen such that text may be input using a virtual keyboard displayed on the touchscreen and/or by handwriting on the touchscreen. The input device 315 may include two or more different devices, such as a keyboard and a touch panel.

The output device 320 may be designed to output visual, audible, and/or haptic signals. The output device 320 may include an electronically controllable display or display device capable of outputting visual data to a user. For example, the output device 320 may include, but is not limited to, an LCD display, an LED display, an OLED display, a projector, or similar display device capable of outputting images, text, or the like to a user. As another, non-limiting, example, the output device 320 may include a wearable display separate from, but communicatively coupled to, the rest of the network node 300, such as a smart watch, smart glasses, a heads-up display, or the like. Further, the output device 320 may be a component of a smart phone, a personal digital assistant, a television, a table computer, a notebook (laptop) computer, a personal computer, a vehicle dashboard, or the like.

The output device 320 may include one or more speakers for producing sound. For example, the output device 320 may produce an audible alert or notification (e.g., a beep or chime). The output device 320 may include one or more haptic devices for producing vibrations, motion, or other haptic feedback. All, or portions, of the output device 320 may be integrated with the input device 315. For example, the input device 315 and output device 320 may form a touchscreen or similar touch-sensitive display. The output device 320 may be located near the input device 315.

The transceiver 325 includes at least one transmitter 330 and at least one receiver 335. The one or more transmitters 330 may be used to communicate with the UE, as described herein. Similarly, the one or more receivers 335 may be used to communicate with network functions in the PLMN and/or RAN, as described herein. Although only one transmitter 330 and one receiver 335 are illustrated, the network node 300 may have any suitable number of transmitters 330 and receivers 335. Further, the transmitter(s) 330 and the receiver(s) 335 may be any suitable type of transmitters and receivers.

3GPP working group SA2 and 3GPP working group SA3 have recently considered whether the protection of URSP rules provisioned in roaming scenarios is adequate in Release-15 to Release-17. That is, whether it is reasonable to rely on trust relationships between H-PLMN and V-PLMN? Further, they have considered whether there is a need to enhance the security/integrity protection of URSP rules when provided from H-PLMN and/or V-PLMN.

3GPP S3-222902 is a discussion paper titled “Protection of URSP rules from H-PLMN” submitted by Ericsson, and this suggests that the trust in the V-PLMN can be rated in a similar way as when using the procedure Steering of Roaming (SoR) or UE Parameter Update (UPU).

A V-PLMN may benefit if the data in URSP messages from the H-PLMN is tampered with. In the case of provisioning an unprotected URSP rule, the V-PLMN could rewrite the URSP rule to save resources locally or downgrade the QoS for specific services, which then may lead to a bad user experience or service disruptions for the user equipment.

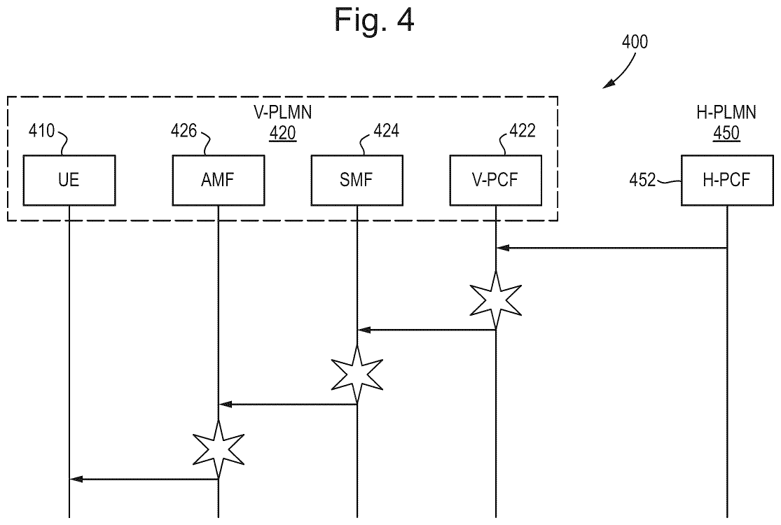

FIG. 4 illustrates a V-PLMN tampering with a URSP rule. A visited Public Land Mobile Network (V-PLMN) 420 comprises a visited Policy Control Function (V-PCF) 422, a Session Management Function (SMF) 424, and an Access and Mobility Management Function (AMF) 426. A home Public Land Mobile Network (H-PLMN) 450 comprises a home PCF (H-PCF) 452; and is the home network of a UE 410. The UE 410 is roaming in the V-PLMN 420. The V-PLMN may have the opportunity to tamper with a URSP sent from the H-PCF 452 to the roaming UE 410 in the V-PCF 422, the SMF 424 or the AMF 426 before delivering it to the UE 410. These tampering opportunities are illustrated with a star in FIG. 4.

3GPP discussion documents S3-222902 “Protection of URSP rules from H-PLMN” and S3-222903 “Draft LS reply Protection of URSP rules from H-PLMN”, both submitted by Ericsson suggest to use the UPU or SoR procedures for protection of a URSP rule. A problem with this proposal is that when reusing the procedures, the protection of UPU/SoR information is triggered by the UDM to the AUSF and the URSP rules are not known to the UDM. A new procedure for the URSP rule protection procedure has to be defined in order to achieve a clear security separation to UPU or SoR.

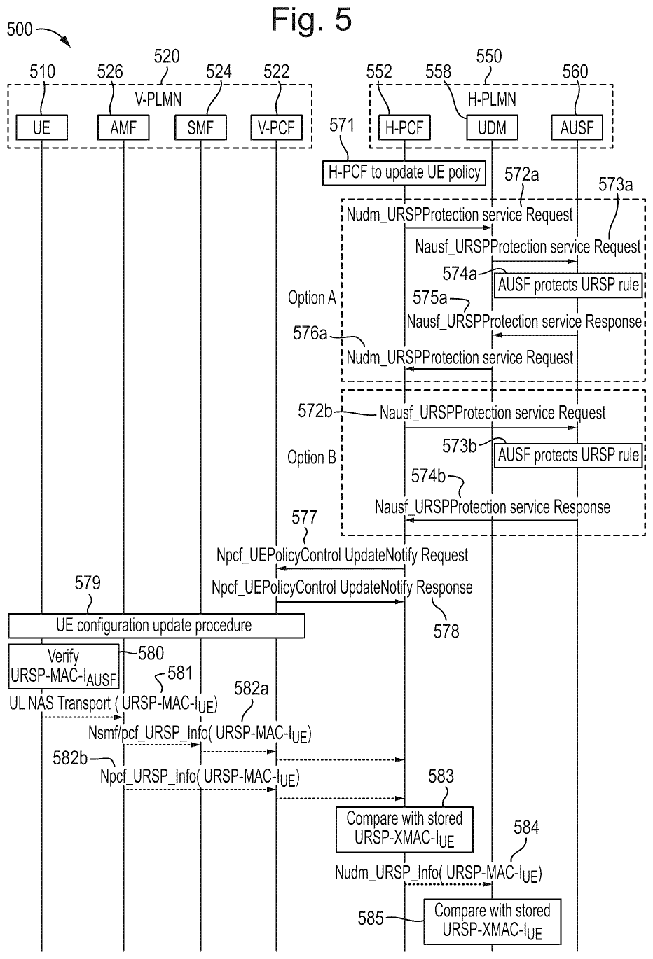

FIG. 5 illustrates a method 500 for URSP rule protection when a UE is roaming in a V-PLMN. FIG. 5 shows a system comprising an H-PMLN 550 and a V-PLMN 520. The H-PLMN comprises an H-PCF 552, a UDM 558, and an AUSF 560. V-PLMN 520 comprises a V-PCF 522, an SMF 524, and an AMF 526. UE 510 is roaming in the V-PLMN 520.

The H-PCF 552 provides a URSP rule for the UE 510 to the UDM 558 or alternatively directly to the AUSF 560 using the mechanism defined in 3GPP TS 23.503 v17.6.0 titled “Policy and charging control framework for the 5G System (Release 17)”. If the H-PCF 552 provides the URSP rule to the UDM 558, the UDM 558 sends this to the AUSF 560. The AUSF 560 protects the URSP rule, creating a protected URSP rule. A separate counter is created in order to prevent replay attacks.

The method 500 commences at 571, when the H-PCF 552 decides to update the URSP rule for the UE 510 roaming in a V-PLMN 520.

Two alternative routes are illustrated in FIG. 5 for the protection of the URSP rule: option (A) and option (B). Both options (A) and (B) result in the AUSF 560 protecting the URSP rule.

According to option A: at 572a, the H-PCF 552 invokes Nudm_URSPProtection service operation message to the UDM 558 and includes URSP Data corresponding to the URSP rule.

At 573a, the UDM 558 selects the AUSF 560 that holds the latest K_{AUSF} of the UE 510. The UDM 558 sends a Nausf_URSPProtection service message to the AUSF 560 with the URSP data to get URSP-MAC-I_{AUSF} and Counter_{URSP} as specified below in the explanation regarding “URSP-MAC-I_{AUSF} generation function”. The UDM 558 may include an ACK Indication in the Nausf_URSPProtection service operation message to signal that it also needs the expected URSP-XMAC-I_{UE}.

At 574a, the AUSF 560 protects the received URSP Data with a URSP-MAC-I_{AUSF}. Further, if the ACK indication is set by the UDM 558, then the AUSF 560 generates a URSP-XMAC-I_{UE}.

At 575a, the AUSF 560 provides the protected URSP data with the URSP-MAC-I_{AUSF} and the Counter_{URSP} to the UDM 558. Further, the AUSF 560 may include the URSP-XMAC-I_{UE}, if the ACK indication was set by the UDM 558.

At 576a, the UDM 558 provides the protected URSP Data with the URSP-MAC-I_{AUSF} and the Counter_{URSP} to the H-PCF 552. The message may include the URSP-XMAC-I_{UE}, if this is provided. Further, UDM 558 may store the URSP-XMAC-I_{UE}, if this is provided.

This marks the end of the route specific to option (A), the procedure continues with step 577.

In an alternative to option (A), option (B) commences at 572b, whereupon the H-PCF 552 selects the AUSF 560 that holds the latest K_{AUSF} of the UE 510. The H-PCF 552 sends a Nausf_URSPProtection service message to the AUSF 560 with the URSP data to get URSP-MAC-I_{AUSF} and Counter_{URSP} as specified below in the explanation regarding “URSP-MAC-I_{AUSF} generation function”. Optionally, the H-PCF 552 may include an ACK Indication in the Nausf_URSPProtection service operation message to signal to the AUSF 560 that it also requires the expected URSP-XMAC-I_{UE}.

At 573b, the AUSF 560 protects the URSP Data with a URSP-MAC-I_{AUSF}. Further, if the ACK indication is set by the H-PCF 552, then the AUSF 560 generates a URSP-XMAC-I_{UE} and returns this to the H-PCF 552.

At 574b, the AUSF 560 provides protected URSP data with the URSP-MAC-I_{AUSF} and the Counter_{URSP} to the H-PCF 552. The message may include the URSP-XMAC-I_{UE}, if this is returned by the AUSF 560. The H-PCF 552 may store the URSP-XMAC-I_{UE}, if it is available.

This marks the end of the route specific to option (B), the procedure continues with step 577.

At 577, the H-PCF 552 creates the UE policy container including UE policy information with the protected URSP data and the URSP-MAC-I_{AUSF} and the Counter_{URSP}. Further, if required, the H-PCF includes an ACK Indication. The H-PCF 552 includes the UE policy container in the Npcf_UEPolicyControl UpdateNotify Request.

At 578, the V-PCF 522 sends a response to H-PCF 552 using Npcf_UEPolicyControl UpdateNotify Response.

At 579, the V-PCF 522 triggers a UE Configuration Update Procedure. The UE Configuration Update Procedure includes sending a UE policy container including UE policy information with the URSP data and the URSP-MAC-I_{AUSF} and the Counter_{URSP} to the UE 510. Further, if required, the V-PCF 522 sends an ACK Indication to the UE 510.

At 580, upon receiving the DL NAS Transport message, the UE 510 calculates the URSP-MAC-I_{AUE} on the received URSP Data and the Counter_{URSP}. The calculation performed by the UE 510 is the same as that performed by the AUSF 560 when creating the protected URSP data, URSP-MAC-I_{AUSF}. Therefore, the URSP-MAC-I_{UE} and the URSP-MAC-I_{AUSF} will match unless the URSP data has been tampered with. The UE 510 verifies whether the URSP-MAC-I_{UE} matches the URSP-MAC-I_{AUSF} value received within the URSP transparent container in the DL NAS Transport message. If the verification of URSP-MAC-I_{AUSF} is successful and the URSP Data contains any parameters that is protected by secured packet, the Mobile Equipment (ME) forwards the secured packet to the USIM. If the verification of URSP-MAC-I_{AUSF} is successful and the URSP Data contains any parameters that are not protected by secure packet, the ME updates its stored parameters with the received parameters in URSP Data. If the verification of URSP-MAC-I_{AUSF} is not successful, then the ME shall not update the URSP data stored in the ME. If the verification of URSP-MAC-I_{AUSF} is not successful, then the ME shall discard the received URSP data.

At 581, if the UDM 558 has requested an acknowledgement from the UE 510 and the UE 510 has successfully verified and updated the URSP Data provided by the H-PCF 552, then the UE 510 sends the UL NAS Transport message to the serving AMF 526. The UE generates the URSP-MAC-I_{UE} and includes the generated URSP-MAC-I_{UE} in a transparent container in the UL NAS Transport message.

At 582, if a transparent container with the URSP-MAC-I_{UE} was received in the UL NAS Transport message, the AMF 526 shall send a Npcf_URSP_Info request message with the transparent container to the V-PCF 522, either via the SMF 524 (step 582a) or directly (step 582b).

At 583, if the H-PCF 552 indicated that the UE 510 is to acknowledge the successful security check of the received URSP Data, then the H-PCF 552 shall compare the received URSP-MAC-I_{UE} with the expected URSP-XMAC-I_{UE} that the H-PCF 552 stored temporarily in step 576a of option (A) or step 574b of option (B).

Note that steps 584 and 585 may not be implemented with option (B). Where option (B) is implemented the method 500 may stop at step 583.

At 584, if the UDM 558 indicated that the UE 510 is to acknowledge the successful security check of the received URSP Data, then the H-PCF 552 sends a Nudm_URSP_Info request message with the transparent container to the UDM 558.

At 585, the UDM 558 compares the received URSP-MAC-I_{UE} with the expected URSP-XMAC-I_{UE} that the UDM 558 stored temporarily in step 575a of option (A).

Accordingly, a UE, and/or a network function in the H-PLMN 550, may determine whether a URSP rule installed on the UE 510 by the V-PLMN 520 has been tampered with.

More details will now be provided with respect to the Nausf_URSPProtection service. The following table (Table 1) illustrates the security related services for URSP data protection that the AUSF provides.

TABLE 1
NF services for URSP provided by AUSF

| | Service | Operation | Example |
|---|---|---|---|
| Service Name | Operations | Semantics | Consumer(s) |
| Nausf_URSPProtection | Protect | Request/Response | UDM, PCF |

The service operation Nausf_URSPProtection, is the operation the AUSF invokes when it needs to calculate the URSP-MAC-I_{AUSF}. URSP-MAC-I_{AUSF} is calculated using a UE specific home key (K_{AUSF}), the Steering Information List and ACK Indication received from the requester network function (NF). The calculated value URSP-MAC-I_{AUSF} and Counter_{URSP} are delivered to the requester NF. If the ACK Indication input is set to indicate that the acknowledgement is requested, then the AUSF shall also compute the URSP-XMAC-I_{UE} and return it to the requester NF in the response.

It should be noted that at reception of Nausf_URSPProtection_Protect request from the UDM or the PCF, the AUSF constructs the URSP header based on the information received from the requester NF, i.e. ACK Indication and list of preferred PLMN/access technology combinations or a secured packet (if provided).

Required inputs for the Nausf_URSPProtection service operation are: Requester ID, SUPI, service name, ACK Indication. Optional inputs for the Nausf_URSPProtection service operation are: URSP transparent container. Required outputs for the Nausf_URSPProtection service operation are: URSP-MAC-I_{AUSF}, Counter_{URSP} or error (counter wrap). Optional outputs for the Nausf_URSPProtection service operation are: URSP-XMAC-I_{UE} (if the ACK Indication input is set to indicate that the acknowledgement is requested, then the URSP-XMAC-I_{UE} shall be computed and returned to the requester NF).

There is also presented herein a URSP-MAC-I_{AUSF} generation function. When deriving a URSP-MAC-I_{AUSF} from K_{AUSF}, the following parameters shall be used to form the input S to the KDF.
FC=0xXY, (XY represents any hexadecimal number)
P0=URSP Data,
L0=length of URSP Data
P1=Counter_{URSP}
L1=length of Counter_{URSP}

The input key Key is K_{AUSF}. The URSP-MAC-I_{AUSF} is identified with the 128 least significant bits of the output of the KDF.

There is also presented herein a URSP-MAC-I_{UE} generation function. When deriving a URSP-MAC-I_{UE} from K_{AUSF}, the following parameters are used to form the input S to the KDF.
FC=0x0xXY, (XY represents any hexadecimal number)
P0=0x01 (URSP Acknowledgement: Verified the URSP Data successfully)
L0=length of URSP Acknowledgement (i.e. 0x00 0x01)
P1=Counter_{URSP}
L1=length of Counter_{URSP}

The input key Key shall be K_{AUSF}. The URSP-MAC-I_{UE} is identified with the 128 least significant bits of the output of the KDF.

There is provided a first network function in a home network, wherein the home network is arranged to communicate with a visited network, the first network function comprising: a transceiver; and a processor coupled to the transceiver. The processor and the transceiver are configured to cause the first network function to: send a request message to a second network function in the home network, the request message comprising user equipment routing selection policy, ‘URSP’, data; receive from the second network function, and in response to the request message, a message comprising protected URSP data; and send a user equipment policy update request comprising the protected URSP data to the third network function for delivery to the user equipment.

By delivering protected URSP data to the UE, the first network function in a home network facilitates the UE being able to verify whether the protected URSP data sent by the first network function matches a URSP rule received from the visited network. The UE is thus able to determine if a URSP rule received from the visited network is authentic.

The UE may be roaming in the visited network. The visited network may be Visited Public Land Mobile Network. The home network may be a Home Public Land Mobile Network. The URSP data may comprise a URSP rule.

The processor and the transceiver may be configured to further cause the first network function to: store the protected URSP data received from the second network function.

The user equipment policy update request comprising the protected URSP data sent to the third network function may also comprise an acknowledgement indication, and the processor and the transceiver may be configured to further cause the first network function to: receive from the third network function, a message comprising an acknowledgement and URSP data from a user equipment; and compare the URSP data received from the third network function with the stored URSP data received from the second network function in order to verify successful URSP rule provisioning in the user equipment.

The second network function in the home network may be a Unified Data Management, and the processor and the transceiver may be configured to further cause the first network function to: send URSP data from the user equipment to the Unified Data Management.

The UDM may then compare the URSP data from the UE with the protected URSP data. The UDM may verify whether the protected URSP data sent by the first network function matches a URSP rule received by the UE from the visited network. The UDM is thus able to determine if a URSP rule received by the UE from the visited network is authentic.

The second network function in the home network may be an Authentication Server Function.

The user equipment policy update request comprising the protected URSP data sent to the third network function may further comprise an acknowledgement indicator, and the transceiver may be further arranged to receive URSP data from the third network function.

The first network function may comprise a Home-Policy Control Function.

The URSP data may comprise at least one of: a URSP rule, a Message Authentication Code for Integrity ‘MAC-I’, a URSP-MAC-I_{AUSF}, a Counter_{URSP}, and a URSP-MAC-I_{UE}.

The third network function may be a Visited-Policy Control Function.

The protected URSP data received from the second network function may be stored in the first network function or in the second network function.

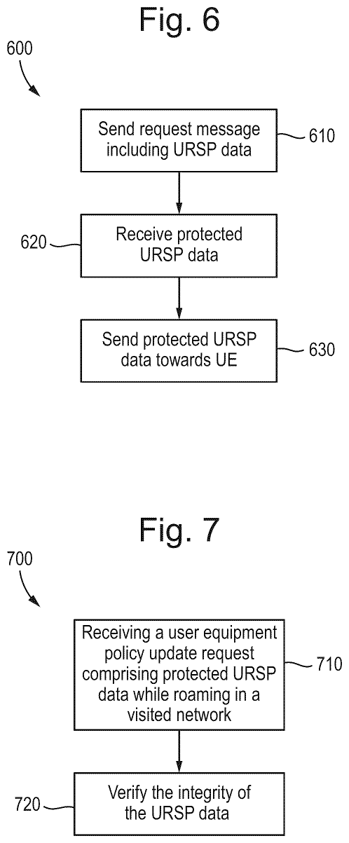

FIG. 6 illustrates a method 600 in a first network function in a home network, wherein the home network is arranged to communicate with a visited network. The method 600 comprises: sending 610 a request message to a second network function in the home network, the request message comprising user equipment routing selection policy, ‘URSP’, data; receiving 620 from the second network function, and in response to the request message, a message comprising protected URSP data; and sending 630 a user equipment policy update request comprising the protected URSP data to the third network function for delivery to the user equipment.

In certain embodiments, the method 600 may be performed by a processor executing program code, for example, a microcontroller, a microprocessor, a CPU, a GPU, an auxiliary processing unit, a FPGA, or the like.

By delivering protected URSP data to the UE, the UE is able to verify whether the protected URSP data sent by the first network function matches a URSP rule received from the visited network. The UE is thus able to determine if a URSP rule received from the visited network is authentic.

The UE may be roaming in the visited network. The visited network may be Visited Public Land Mobile Network. The home network may be a Home Public Land Mobile Network. The URSP data may comprise a URSP rule.

The method may further comprise storing the protected URSP data received from the second network function.

The user equipment policy update request comprising the protected URSP data sent to the third network function may also comprise an acknowledgement indication, and the method may further comprise: receiving from the third network function, a message comprising an acknowledgement and URSP data from a user equipment; and comparing the URSP data received from the third network function with the stored URSP data received from the second network function in order to verify successful URSP rule provisioning in the user equipment.

The second network function in the home network may be a Unified Data Management, and the method may further comprise sending URSP data from the user equipment to the Unified Data Management.

The UDM may then compare the URSP data from the UE with the protected URSP data. The UDM may verify whether the protected URSP data sent by the first network function matches a URSP rule received by the UE from the visited network. The UDM is thus able to determine if a URSP rule received by the UE from the visited network is authentic.

The second network function in the home network may be an Authentication Server Function.

The user equipment policy update request comprising the protected URSP data sent to the third network function may further comprise an acknowledgement indicator, and the method may further comprise receiving URSP data from the third network function.

The first network function may comprise a Home-Policy Control Function.

The URSP data may comprise at least one of: a Message Authentication Code for Integrity ‘MAC-I’, a URSP-MAC-I_{AUSF}, a Counter_{URSP}, and a URSP-MAC-I_{UE}.

The third network function may be a Visited-Policy Control Function.

The protected URSP data received from the second network function may be stored in the first network function or in the second network function.

There is further provided a user equipment comprising: a transceiver; and a processor coupled to the transceiver. The processor and the transceiver configured to cause the user equipment to: receive a user equipment policy update request comprising a protected user equipment routing selection policy, ‘URSP’, data while roaming in a visited network; and verify the integrity of the received URSP data.

FIG. 7 illustrates a method 700 in a user equipment, the method 700 comprising: receiving 710 a user equipment policy update request comprising a protected user equipment routing selection policy, ‘URSP’, data while roaming in a visited network; and verifying 720 the integrity of the received URSP data.

In certain embodiments, the method 700 may be performed by a processor executing program code, for example, a microcontroller, a microprocessor, a CPU, a GPU, an auxiliary processing unit, a FPGA, or the like.

As discussed above, if the H-PLMN provisions an unprotected URSP rule to the UE in the V-PLMN, then there is a risk that the V-PLMN could tamper with or rewrite the URSP rule to save resources locally or downgrade the QoS for specific services. Such tampering or re-writing may lead to a bad user experience or service disruptions. The V-PLMN may have the chance to tamper the URSP in the V-PCF, SMF or AMF before delivering it to the UE.

The H-PCF integrity protection mechanism described herein protects the URSP rule so that the UE and/or a network function in the H-PLMN can verify whether the URSP rule was tampered with or rewritten in the V-PLMN or not.

The solution presented herein introduces anew Service Based Architecture service for the PCF to query the AUSF to protect the URSP rule. Further, this new Service Based Architecture requires new functionality in the UE to verify the URSP rule. Further, the PCF may be enhanced to verify the acknowledgement from the UE.

There is described herein an H-PCF that provides a URSP rule either directly to the AUSF or via the UDM, an AUSF integrity operation protects the URSP rule and provides also an expected result back to the H-PCF, in case acknowledgements are requested. The H-PCF provides the protected rule to the UE in the V-PLMN and verifies the received acknowledgement with the expected result.

Accordingly there is provided an apparatus comprising: a transceiver; and a processor coupled to the transceiver, the processor and the transceiver configured to cause the apparatus to: send a request message to a second network function on another apparatus [which may be either the UDM or AUSF], comprising the URSP data, ACK Indication; receiving in response to the request message from the second network function on another apparatus [which may be either the UDM or AUSF] a message comprising URSP data, URSP-MAC-I_{AUSF}, Counter_{URSP}, URSP-XMAC-I_{UE}; store the received URSP-XMAC-I_{UE}; select a third network function on another apparatus in a different network [the other apparatus may be a V-PCF]; send a UE policy update request comprising URSP data, URSP-MAC-I_{AUSF}, Counter_{URSP}; receive in response to the UE policy update request from the third network function a message comprising an acknowledgement, comprising a URSP-MAC-I_{UE}; comparing the received URSP-MAC-I_{UE} with the stored URSP-XMAC-I_{UE} in order to verify the successful URSP rule provisioning. The apparatus may be an H-PCF.

It should be noted that the above-mentioned methods and apparatus illustrate rather than limit the invention, and that those skilled in the art will be able to design many alternative arrangements without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

Further, while examples have been given in the context of particular communication standards, these examples are not intended to be the limit of the communication standards to which the disclosed method and apparatus may be applied. For example, while specific examples have been given in the context of 3GPP, the principles disclosed herein can also be applied to another wireless communication system, and indeed any communication system which uses routing rules.

The method may also be embodied in a set of instructions, stored on a computer readable medium, which when loaded into a computer processor, Digital Signal Processor (DSP) or similar, causes the processor to carry out the hereinbefore described methods.

The described methods and apparatus may be practiced in other specific forms. The described methods and apparatus are to be considered in all respects only as illustrative and not restrictive. The scope of the invention is, therefore, indicated by the appended claims rather than by the foregoing description. All changes which come within the meaning and range of equivalency of the claims are to be embraced within their scope.

The following abbreviations are relevant in the field addressed by this document: 5GC, 5G Core Network; 5GS, 5G System; AF, Application Function; AMF, Access and Mobility Management Function; AUSF, Authentication Server Function; ML, Machine Learning; NAS, Non Access Stratum; NF, Network Function; PCF, Policy Control Function; SBA, Service Based Architecture; SMC, Security Mode Command; SMF, Session Management Function; SUCI, Subscription Concealed Identifier; SUPI, Subscription Permanent Identifier; UE, User Equipment; UDM, Unified Data Management; UDR, Unified Data Repository; USIM, Universal Subscriber Identity Module; KDF, Key Derivation Function; MAC-I, Message Authentication Code for Integrity; URSP, UE Routing Selection Policy; VPLMN, Visited Public Land Mobile Network; HPLMN, Home Public Land Mobile Network; QoS, Quality of Service; V-PCF, Visited PCF; H-PCF, Home PCF; and ACK, Acknowledgement.

1. A first network function in a home network, comprising:
at least one memory; and
at least one processor coupled with the at least one memory and configured to cause the first network function to:
send a request message to a second network function in the home network, wherein the request message comprises user equipment routing selection policy (URSP) data;
receive, from the second network function and in response to the request message, a message comprising protected URSP data;
send a user equipment policy update request comprising the protected URSP data to a third network function.

2. The first network function of claim 1, wherein the at least one processor is further configured to cause the first network function to:
store the protected URSP data received from the second network function.

3. The first network function of claim 2, wherein the user equipment policy update request further comprises an acknowledgement indication, and wherein the at least one processor is further configured to cause the first network function to:
receive, from the third network function, a message comprising an acknowledgement and URSP data from a user equipment (UE); and
compare the URSP data received from the third network function with the stored URSP data received from the second network function to verify successful URSP rule provisioning in the UE.

4. The first network function of claim 1, wherein the second network function in the home network is a Unified Data Management, and the at least one processor is configured to cause the first network function to:
send URSP data to the Unified Data Management.

5. The first network function of claim 1, wherein the second network function in the home network is an Authentication Server Function.

6. The first network function of claim 1, wherein the user equipment policy update request further comprises an acknowledgement indicator, and wherein the at least one processor is further configured to receive URSP data from the third network function.

7. The first network function of claim 1, wherein the first network function comprises a Home-Policy Control Function.

8. The first network function of claim 1, wherein the URSP data includes: a URSP rule, a Message Authentication Code for Integrity (MAC-I), a URSP-MAC-I_{AUSF}, a Counter_{URSP}, or a URSP-MAC-I_{UE}.

9. The first network function of claim 1, wherein the third network function is a Visited-Policy Control Function.

10. The first network function of claim 1, wherein the protected URSP data received from the second network function is stored in the first network function or in the second network function.

11. A method performed by a first network function in a home network, the method comprising:
sending a request message to a second network function in the home network, wherein the request message comprise user equipment routing selection policy (URSP data;
receiving, from the second network function and in response to the request message, a message comprising protected URSP data; and
sending a user equipment policy update request comprising the protected URSP data to a third network function.

12. The method of claim 11, further comprising: storing the protected URSP data received from the second network function.

13. The method of claim 12, wherein the user equipment policy update request comprises an acknowledgement indication, and wherein the method further comprises:
receiving, from the third network function, a message comprising an acknowledgement and URSP data from a user equipment (UE); and
comparing the URSP data received from the third network function with the stored URSP data received from the second network function verify successful URSP rule provisioning in the UE.

14. The method of claim 11, wherein the second network function in the home network is a Unified Data Management, and wherein the method further comprises: sending URSP data to the Unified Data Management.

15. The method of claim 11, wherein the second network function in the home network is an Authentication Server Function.

16. The method of claim 11, wherein the user equipment policy update request further comprises an acknowledgement indicator, and wherein the method further comprises: receiving URSP data from the third network function.

17. The method of claim 11, wherein the first network function comprises a Home-Policy Control Function.

18. The method of claim 11, wherein the URSP data includes: a URSP rule, a Message Authentication Code for Integrity (MAC-I), a URSP-MAC-I_{AUSF}, a Counter_{URSP}, or a URSP-MAC-I_{UE}.

19. A user equipment for wireless communication, comprising:
at least one memory; and
at least one processor coupled with the at least one memory and configured to cause the UE to:
receive a user equipment policy update request comprising f-protected user equipment routing selection policy (URSP) data while roaming in a visited network; and
verifying an integrity of the received URSP data.

20. A method performed by a user equipment-(UE), the method comprising:
receiving a user equipment policy update request comprising protected user equipment routing selection policy (URSP) data while roaming in a visited network; and
verifying an integrity of the received URSP data.
